(19) United States
(12) Patent Application Publication
(10) Pub. No.: US 2008/0008387 A1
(43) Pub. Date: Jan. 10, 2008

(54) Method and apparatus for recognition of handwritten symbols

(76) Inventors: Yi-Hsun E. Cheng, Sunnyvale, CA (US); Nada P. Matic, Santa Clara, CA (US); Raymond A. Trent, San Jose, CA (US)

Correspondence Address: WAGNER, MURABITO & HAO LLP, 123 Westridge Drive, Watsonville, CA, 95076, US

(21) Appl. No.: 11/484,051

(22) Filed: Jul. 6, 2006

(51) Int. Cl. G06K 9/18

(52) U.S. Cl. 382/186; 382/185

(57) ABSTRACT

A method and apparatus for recognition of handwritten symbols. A plurality of strokes is received at a common input region of an electronic device, wherein the plurality of strokes in combination defines a plurality of symbols. Sequential combinations of the plurality of strokes are analyzed with a plurality of symbol recognition engines to determine at least one possible symbol of the plurality of symbols defined by the plurality of strokes, wherein at least one of the plurality of symbol recognition engines is configured to identify symbols comprising a particular number of strokes.

### FIELD OF INVENTION

The present invention generally relates to the field of digital systems. Specifically, embodiments of the present invention relate to a method and apparatus for recognition of handwritten symbols.

### BACKGROUND OF THE INVENTION

Handwriting recognition-based text input allows users to enter symbols on-line using a writing instrument (e.g., a pen, stylus, or finger) and an electronic input device (e.g. a tablet, digitizer, or touchpad). A typical handwriting recognition input device captures X, Y, and time coordinates of the writing instrument trajectory. The handwriting may then be automatically converted to digital text. Handwriting recognition software uses the input stroke sequence to perform the writing to text conversion (e.g. it identifies the intended symbol sequence).

Typically, a user can enter symbols in either restrictive way (e.g. boxed mode or using timeouts) or unconstrained way (e.g. continuously printed or cursive) by writing in natural order (e.g., left-to-right for writing in English). In general, the more restrictive the symbol entry is, the easier the symbol recognition is to resolve. However, restrictive symbol entry is often unnatural, increasing the user's learning time of the symbol recognition system and slowing down the text input process. In contrast, unconstrained symbol entry is often computationally intensive and error prone. Typically, unconstrained symbol entry recognition systems need to pre-process the handwritten data by appropriately segmenting, grouping and re-sequencing such recorded handwritten data before recognition.

As a result of technological advances, many small electronic devices, such as mobile phones, are including handwriting symbol entry functionality. However, these small devices typically have input devices with small symbol input areas. Often these input devices are only have enough space for a user to write a single symbol. On these input devices, symbols cannot be written in the natural order (e.g., side-by-side and left-to-right) that is natural to many languages. These input devices require that symbols be written on top of each other.

Due to symbols being written on top of each other, the segmentation of symbols entered using small input devices adds additional complexity to the symbol input systems described above. Current solutions do exist for handwriting recognition on small input devices. However, in order to address the complex symbol segmentation problem, these current solutions provide users with unnatural symbol entry or have reduced accuracy.

For example, some small input devices require users to learn special alphabets, such as a unistroke alphabet. A unistroke alphabet is designed such that each symbol is a single stroke. Thus, while symbol segmentation is easily addressed, a user is forced to learn an unnatural and distorted alphabet. Other small input devices use a timeout mechanism or other external segmenting signal to address the symbol segmentation problem. A user is required to pause after the entry of a symbol. Once the timeout occurs, the symbol recognition is performed. This technique is also unnatural as it requires a user to wait for a timeout after each symbol is entered. Furthermore, it is error-prone, as a user may not enter strokes fast enough, causing a timeout to occur before the user is finished with entering the symbol, resulting in an incorrectly identified symbol. Furthermore, the use of external segmenting signals, e.g., pressing a button to indicate the end of a symbol, is also error prone and awkward.

### SUMMARY OF THE INVENTION

Various embodiments of the present invention provide a method and apparatus for integrated segmentation and recognition of handwritten symbols written at least partially on top of each other. In one embodiment, a plurality of strokes is received at a common input region of an electronic device, wherein the plurality of strokes in combination define a plurality of symbols. In one embodiment, the plurality of symbols comprises phonetic representations of an ideographic language.

In one embodiment, it is determined whether a stroke of the plurality of strokes represents a non-symbol gesture such that if a stroke is determined to represent a non-symbol gesture, the stroke is ignored at the plurality of symbol recognition engines.

Sequential combinations of the plurality of strokes are analyzed with a plurality of symbol recognition engines to determine at least one possible symbol of the plurality of symbols defined by the plurality of strokes, wherein at least one of the plurality of symbol recognition engines is configured to identify symbols comprising a particular number of strokes. In one embodiment, the plurality of symbol recognition engines comprises statistical classifiers. In one embodiment, at least one of the plurality of symbol recognition engines is configured to identify symbols comprising a particular number of strokes. In one embodiment, the plurality of symbol recognition engines comprises a one stroke symbol recognition engine, a two stroke symbol recognition engine, a three stroke symbol recognition engine. In one embodiment, the plurality of symbol recognition engines also comprises a four stroke symbol recognition engine.

It should be understood that the plurality of symbol recognition engines need not be separate modules, but could be a single module that performs a similar function of analyzing combinations of strokes in a manner that rejects hypotheses comprising non-symbols formed by strokes from overlapping symbols.

In one embodiment, the analyzing does not require the use of an external mechanism to identify the possible symbol. In one embodiment, the external mechanism that is not required comprises at least one of an external segmenting signal and a stroke dictionary.

In one embodiment, possible combinations of the plurality of strokes are determined according to a binary state machine. In one embodiment, the possible combinations are limited according to a predetermined limitation. A symbol is selected from the possible combinations.

In another embodiment, the present invention provides an apparatus for recognition of handwritten symbols. A stroke receiver is operable to receive a plurality of strokes entered into a common input region, wherein the plurality of strokes in combination define a plurality of symbols and wherein at least one stroke of one symbol is spatially superimposed over at least one stroke of another symbol. In one embodiment, the stroke receiver is a stroke input device of a handheld computing device. In one embodiment, each stroke of the plurality of strokes is associated with only one symbol of the plurality of symbols. In one embodiment, the plurality of symbols comprises phonetic representations of an ideographic language.

In one embodiment, the stroke analyzer is configured for determining whether a stroke of the plurality of strokes represents a non-symbol gesture and for ignoring the stroke at the plurality of symbol recognition engines if the stroke represents a non-symbol gesture.

A stroke analyzer is operable to sequentially analyze the plurality of strokes to determine at least one possible symbol defined by the plurality of strokes. The stroke analyzer comprises a plurality of symbol recognition engines for analyzing sequential combinations of the plurality of strokes, wherein the plurality of symbol recognition engines are for identifying symbols comprising a particular number of strokes. In one embodiment, the plurality of symbol recognition engines comprises a one stroke symbol recognition engine for identifying symbols comprising one stroke, a two stroke symbol recognition engine for identifying symbols comprising two strokes, a three stroke symbol recognition engine for identifying symbols comprising three strokes. In one embodiment, the plurality of symbol recognition engines also comprises a four stroke symbol recognition engine for identifying symbols comprising four strokes. In one embodiment, each of the plurality of symbol recognition engines determines a probability that strokes analyzed by a respective symbol recognition engine of the plurality of symbol recognition engines is the possible valid symbol.

In one embodiment, the stroke analyzer is configured for determining possible combinations of the plurality of strokes according to a binary state machine and limiting the possible combinations according to a predetermined limitation. In one embodiment, the plurality of symbol recognition engines comprises statistical classifiers. In one embodiment, at least one symbol recognition engine of the plurality of symbol recognition engines is configured to recognize at least two symbols of the plurality of symbols connected by at least one common stroke.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1A is a block diagram showing components of an exemplary small form factor device, in accordance with an embodiment of the present invention.

FIG. 1B is a diagram showing the exemplary input of a word using a handwriting input device, in accordance with an embodiment of the present invention.

FIG. 2 is a block diagram showing components of a handwriting recognition engine, in accordance with one embodiment of the invention.

FIG. 3A illustrates an exemplary input image for the word “do”, in accordance with an embodiment of the present invention.

FIG. 3B illustrates a binary state machine for the three-stroke input of the word “do”, in accordance with an embodiment of the present invention.

FIG. 4 is a flowchart diagram illustrating steps in a process for recognizing handwritten symbols, in accordance with one embodiment of the present invention.

FIG. 5 is a flowchart diagram illustrating steps in a process for analyzing a stroke, in accordance with one embodiment of the present invention.

### DETAILED DESCRIPTION

Reference will now be made in detail to the various embodiments of the invention, examples of which are illustrated in the accompanying drawings. While the invention will be described in conjunction with the various embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well-known methods, procedures, components, and circuits have not been described in detail so as not to unnecessarily obscure aspects of the present invention.

For purposes of the present application the term symbols refers one or more handwritten strokes intended to convey meaning. For instance, symbols are intended to include, but not be limited to, characters of various alphabets, ideograms for ideographic languages, phonetic symbols, numerals, mathematical symbols, punctuation symbols, and the like.

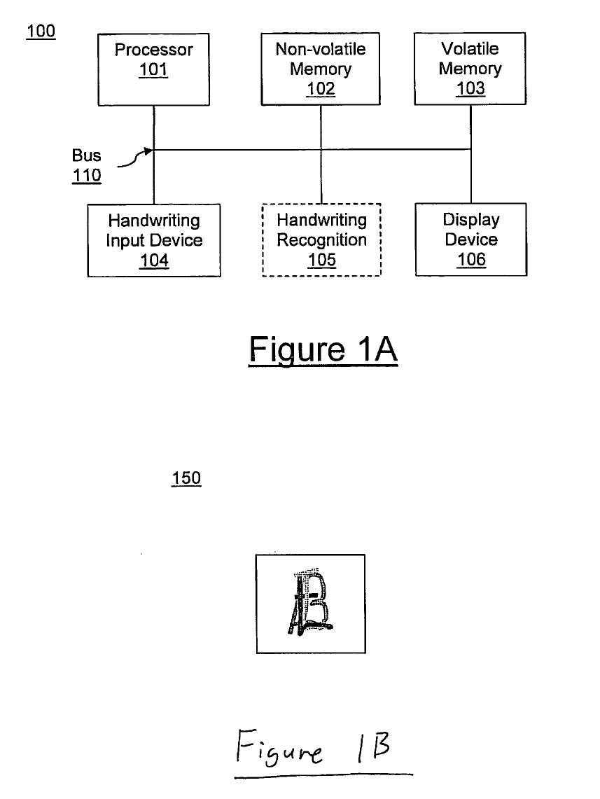

Various embodiments of the present invention provide a handwriting recognition based method for performing text entry into the computer devices where the area allocated to text entry is small relative to the size of the written symbols. For example, the area allocated for text entry may only be able to receive one or two symbols side-by-side, where all additional symbols must be overlapping. FIG. 1B illustrates an exemplary input on a small area allocated to text entry. In particular, symbols are entered in a natural manner, and do not require a user to learn a special alphabet or to rely on a timeout or any other external mechanism aimed at separating written symbols. Embodiments of the present invention provide a method for recognizing handwritten symbols including receiving a plurality of strokes at a common input region of an electronic device, wherein the plurality of strokes in combination define a plurality of symbols. Sequential combinations of the plurality of strokes are analyzed with a plurality of symbol recognition engines to determine at least one possible symbol of the plurality of symbols defined by the plurality of strokes, wherein at least one of the plurality of symbol recognition engines is configured to identify symbols comprising a particular number of strokes.

FIG. 1A is a block diagram showing components of an exemplary small form factor electronic device 100, in accordance with an embodiment of the present invention. In general, electronic device 100 comprises bus 110 for communicating information, processor 101 coupled with bus 110 for processing information and instructions, read-only (non-volatile) memory (ROM) 102 coupled with bus 110 for storing static information and instructions for processor 101, and random access (volatile) memory (RAM) 103 coupled with bus 110 for storing information and instructions for processor 101. Electronic device 100 also comprises handwriting input device 104 coupled with bus 110 for receiving stroke input, handwriting recognition engine 105 coupled with bus 110 for performing handwriting recognition on received stroke input, and display device 106 coupled with bus 110 for displaying information.

In one embodiment, handwriting input device 104 is operable to receive pen-, stylus-, or finger-based handwritten input from a user. For example, handwriting input device 104 may be a digitizing tablet, a touchpad, an inductive pen tablet, or the like. Handwriting input device 104 is operable to capture X and Y coordinate information of the input in the form of stroke data. In other words, handwriting input device 104 is a coordinate entry device for detecting in real-time symbol strokes written in the natural stroke order of a symbol and/or word. In one embodiment, the individual symbols' strokes include positional and temporal information derived from the motion of the object contacting, moving across, and leaving the surface of the handwriting input device 104. In another embodiment, where the handwriting input device 104 is an inductive device placed behind display device 106, the individual symbols strokes include positional and temporal information derived from the motion of the object contacting, moving across, and leaving the surface of the display device 106. In one embodiment, strokes are stored in one of non-volatile memory 102 and volatile memory 103, for access by handwriting recognition engine 105. In one embodiment, the symbols entered by a user are phonetic representations of an ideographic language. In one embodiment, the symbols are non-cursive.

In one embodiment, handwriting input device 104 is small enough such that symbols input by a user cannot be written side-by-side (e.g., left to right or top to bottom), but rather on top of one another. For example, in one embodiment handwriting input device 104 has a surface area of less than one square inch. FIG. 1B is a diagram 150 showing the exemplary input of a word using handwriting input device 104, in accordance with an embodiment of the present invention. Diagram 150 illustrates the input of the word “BELL” using a small form factor handwriting input device. In particular, the symbols B, E, L and L are input on top of one another. It should be appreciated that embodiments of the present invention are operable to input symbols written side-by-side, for example short words such as “AN” and “TO”. In one embodiment, the end of a word is indicated by special gesture, button press, timeout, or other signal.

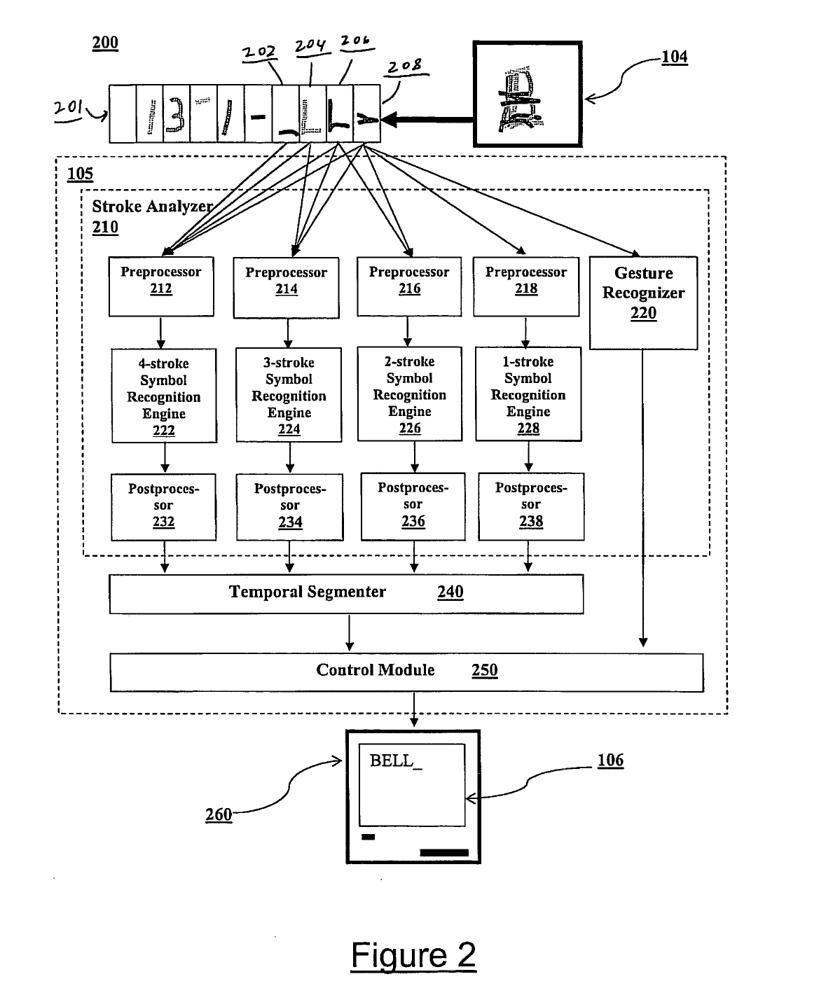

With reference to FIG. 1A, handwriting recognition engine 105 is operable to receive strokes input at handwriting input device 104, and performs symbol recognition on the strokes. It should be appreciated that handwriting recognition engine 105 may be implemented as hardware, software, and/or firmware within electronic device 100. Moreover, it should be appreciated that handwriting recognition engine 105, as shown in dotted lines, indicates handwriting recognition functionality that can be a standalone component or distributed across other components of electronic device 100. For instance, it should be appreciated that different functions of handwriting recognition engine 105 may be distributed across the components of electronic device 100, such as processor 101, non-volatile memory 102, and volatile memory 103. Operation of handwriting recognition engine 105 is discussed below, e.g., with reference to FIG. 2. Handwriting recognition engine 105 is operable to output recognized symbols.

Display device 106 utilized with electronic device 100 may be a liquid crystal device (LCD) or other display device suitable for creating graphic images and alphanumeric or ideographic symbols recognizable to the user. Display device 106 is operable to display recognized symbols. In one embodiment, the recognized symbols are displayed as text.

FIG. 2 is a block diagram showing components of a system 200 for performing handwriting recognition, in accordance with one embodiment of the invention. In one embodiment, the present invention provides a system 200 for performing handwriting recognition based in text entry into a computer device (e.g., electronic device 100 of FIG. 1A) where the area allocated to text entry is small relative to the writing instrument. A user is able to enter strokes of symbols in natural stroke order.

System 200 includes handwriting input device 104, handwriting recognition engine 105 and display device 106. As described above, stroke input is received at handwriting input device 104. The stroke input is represented in FIG. 2 as strokes 202, 204, 206 and 208. In particular, stroke 208 is the most recent stroke entered, preceded by strokes 206, 204 and 202. As shown, four strokes are processed by handwriting recognition engine 105. However, it should be appreciated that any number of strokes can be processed, and that embodiments of the present invention are not limited to the present embodiment. For instance, while the present embodiment is described as processing the four most recently received strokes, other embodiments may directed towards other numbers of most recently received strokes (e.g., the last three strokes received or the last five strokes received).

In one embodiment, handwriting input device 104 is operable to sense and report a trace of contact movement. The traces of contact are grouped into sets of points in X, Y coordinates called strokes. A stroke buffer 201 temporarily holds the entered strokes to allow forming different hypotheses of segmenting the stroke sequences.

Handwriting recognition engine 105 is operable to recognize a registered set of symbols (e.g., a-z, 0-9, A-Z, or ideographic symbols), based on user stroke input. Strokes 202, 204, 206 and 208 are processed by handwriting recognition engine 105 for performing handwriting recognition. In one embodiment, strokes 202, 204, 206 and 208 are processed at stroke analyzer 210. Stroke analyzer 210 is operable to sequentially analyze a plurality of strokes to determine at least one possible symbol defined by the plurality of strokes. As shown, stroke analyzer 210 includes four symbol recognition engines 222, 224, 226 and 228, for performing symbol recognition on symbols including the most recently entered four, three, two and one strokes, respectively. It should be understood that symbol recognition engines 222, 224, 226 and 228 need not be separate modules, but could be a single module that performs a similar function of analyzing combinations of strokes in a manner that rejects hypotheses comprising non-symbols formed by strokes from overlapping symbols.

In one embodiment, stroke analyzer 210 also includes gesture recognizer 220 for determining whether the most recent stroke is part of a symbol or is indicating a gesture. A handwritten stroke can be either a part of a symbol (the entered text) or a gesture to issue a command. Because gestures represent a pre-defined set of strokes, a gesture recognizer 210 can filter out gesture strokes prior to symbol recognition.

Once a stroke is confirmed not to be a gesture, the symbol recognition and segmentation begins. Strokes 202, 204, 206 and 208 stored in temporary buffer are used for tentative symbol generation. Based on available strokes in the buffer, a number of new tentative symbols can be formed with respect to the latest entered stroke. The number of new tentative symbols is determined by using a prior knowledge about the maximum number of strokes for a particular symbol set. Each tentative symbol by default is assumed to be either a new symbol comprising only the latest stroke, or a new symbol comprising the latest stroke combined with one or more previous strokes.

In one embodiment, prior to sending strokes to symbol recognition engines, the strokes are subject to preprocessing at preprocessors 212, 214, 216 and 218. Preprocessors 212, 214, 216 and 218 are operable to perform various transformations to convert raw data (e.g., X, Y coordinates) into a representation that facilitates the recognition process. In one embodiment, the preprocessing includes operations such as scaling, normalization and feature generation, e.g., converting the input representation into the representation more suitable for the recognition.

Preprocessing techniques incorporate human knowledge about the task at hand, such as known variances and relevant features. For example, preprocessing can include key point extraction, noise filtration, and feature extraction. In one embodiment, the output of preprocessors 212, 214, 216 and 218 is a vector that represents the input in the form of a feature vector defined in multidimensional feature space. This hyperspace is divided into a number of sub-spaces that represent the individual classes of the problem. A classification process determines which sub-space feature vectors the particular input belongs.

After preprocessing, strokes are passed on to respective symbol recognition engines 222, 224, 226 and 228 for performing symbol recognition on combinations of the last four strokes, last three strokes, last two strokes, and last stroke, respectively. In one embodiment, the input strokes in the form of feature vector are matched against the features of registered classes. It should be appreciated that strokes recognized as gestures are not passed on the symbol recognition engines 222, 224, 226 and 228.

In one embodiment, symbol recognition engines 222, 224, 226 and 228 comprise statistical recognizers and are operable to perform classification among pre-defined set of classes. In one embodiment, symbol recognition engines 222, 224, 226 and 228 are also trained to reject a non-legitimate combination of strokes. The symbol recognition engines 222, 224, 226 and 228 output scores reflecting the similarity between the preprocessed input signal and the output class. A high output score suggests acceptance of the associated tentative symbol while low scores on all classes suggests rejection of the associated hypothesis. In one embodiment, the output score indicates a probability that the strokes analyzed by the respective symbol recognition engine are a possible symbol. It should be appreciated that symbol recognition engines 222, 224 and 226 analyze each combination of strokes within the respective symbol recognition as a whole, rather than individually analyzing each stroke.

In one embodiment, each symbol recognition engine 222, 224, 226 and 228 is operable to achieve good performance for regular classification tasks and is operable to reject queries of meaningless symbols observed in an incorrect hypothesis window in which strokes are from two intended symbols when generating an effective “confidence judgment” for rejecting ambiguous input patterns. In one embodiment, each symbol recognition engine employs a template-matching procedure that exhaustively performs matching between an input symbol and a group of templates by measuring their similarities. The correct result of the comparison is the template with the highest similarity score.

In one embodiment, the template matching includes:
Categorized template matching: The templates are categorized into groups by the number of strokes. These groups divide the recognition task into mutually exclusive subtasks and thus boost the recognition performance.
Similarity measurements: A function measuring the similarity between the transformed input and all templates, which reports the highest scoring comparison as the intended class.
Penalty factor for subset class recognition: A subset class is a simple class that also represents a part of a more complex class (e.g., I and C are subset classes of K in handwriting). A penalty constant is factored into the similarity measure so that a subset class will not get a high score. For example, when an input “I” is matched against the template “K”.
Allograph-based recognition: Variations in handwriting style for the same symbol sometimes results in distinct subsets referred to as allographs. For example, lowercase “z” can also be written like “3”, and this second allograph contains features that are distinct from a regular “z”. The recognition task treats allographs as separate classes.

It should be appreciated that other types of statistical classifiers may be used in symbol recognition engines 222, 224, 226 and 228, such as neural networks and the like, and that the present invention is not limited to the use of template matching.

In one embodiment, the matching results of the symbol recognition engines are subjected to postprocessing at postprocessors 232, 234, 236 and 238. The postprocessing is operable to reduce existing confusions among classes. The recognition result is a class label together with a confidence level, e.g., a recognition score.

Stroke analyzer 210 is operable to perform symbol recognition on received strokes. Temporal segmenter 240 is operable to receive the symbol recognition results and to select the best fit symbol based on the symbol recognition results of the symbol recognition engines.

Temporal segmenter 240 evaluates all possible hypotheses, e.g., ways of combining the sequence of input strokes. The hypothesis with the highest score in the particular part of the stroke sequence wins and the accumulated symbol sequence associated with the winning hypothesis is output. To generate all possible solutions, in one embodiment, temporal segmenter 240 utilizes a binary state machine that expands exponentially as new strokes are added to the system. The state machine is binary in that each state has a maximal number of two offspring states representing two new possible hypotheses based on the parent state: the newly added stroke is either a single stroke symbol or the last stroke appended to the accumulated strokes in the parent state.

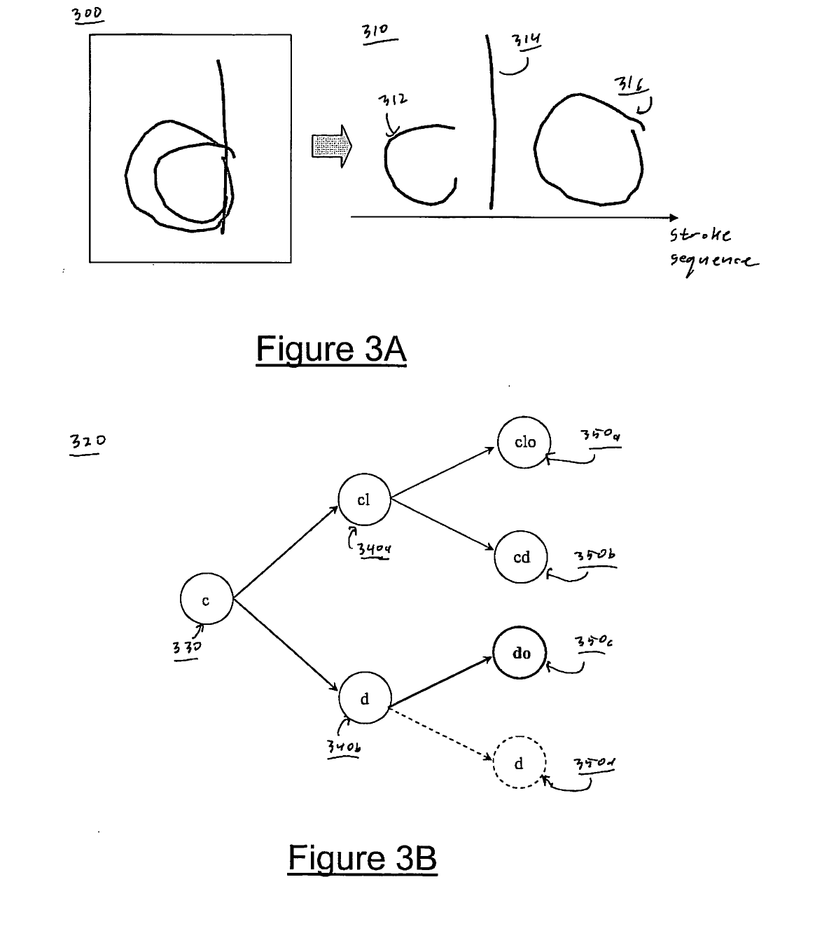

FIG. 3A illustrates an exemplary input image 300 for the word “do”, in accordance with an embodiment of the present invention. The word “do”, as shown, includes three strokes 312, 314 and 316. Input image 300 illustrates the superimposed input of the strokes and graph 310 illustrates the strokes as entered in the stroke sequence domain.

FIG. 3B illustrates a binary state machine 320 for the three-stroke input of the word “do”, in accordance with an embodiment of the present invention. Binary state machine keeps track of valid hypotheses for each combination of strokes. Hypothesis 330 is the only hypothesis for input stroke 312. Hypotheses 340a and 340b are both valid hypotheses for the combination of input strokes 312 and 314. Hypotheses 350a, 350b and 350c are valid hypotheses for input strokes 312, 314 and 316. Hypotheses 350d is invalid, as the class “d” is known to consist of less than three strokes, thus the hypothesis for a three-stroke “d” can be ruled out. The desired output “do” is indicated at hypothesis 350c.

Binary state machines grow exponentially. In order to limit growth of the binary state machine, in order to improve processing speed and system overhead, various constraints may be placed on temporal segmenter 240.

In one embodiment, an arbitrary limit is imposed on the number of strokes for a legitimate symbol. For example, the maximal numbers of strokes are limited to be less than four, three and two strokes for uppercase letters, lowercase letters, and digits, respectively. Hypotheses that assume a symbol with a number of strokes exceeding these limits has zero possibility, thus, will not be kept in the state machine.

In one embodiment, the depth of the binary state machine is constrained. This constraint forces a firing of the accumulated strokes and delivers the most confidant hypothesis (state) in the machine. This constraint could unload strokes of an unfinished symbol from the stroke buffer and thus it is prone to segmentation errors. One goal of the segmentation task is to avoid reaching this constraint.

Temporal segmenter 240 is operable to receive the symbol recognition results and to separate the sequence of events into sets of mutually exclusive joint events. This fits to the general framework of Hidden Markov Model (HMM), which models hidden states from a sequence of observations. Identifying the path with the highest likelihood in the defined HMM gives the most probable answer to the segmentation. The complexity of a HMM is dictated by the order of dependency among consecutive states. In this problem domain, the order of dependency is equal to the maximal number of strokes per symbol (e.g., four) for the registered set of symbols. Thus, any hypothesis that involves more than four strokes can be excluded from the HMM immediately.

The confidence of a state, as determined by temporal segmenter 240, comes from two primary sources: the confidence in the new hypothetical symbol and that of its preceding string. The preceding string may come from the parent state or an ancestor state. For example, state 350a reflects a hypothesis of appending a new symbol “o” to its parent state 340a, whereas state 350b negates the local assumption (of a symbol that looks like “I”) of 340a and appends a new symbol “d” to state 330. In one embodiment, the two confidences are weighted equally.

The present invention also provides for enhanced management of the binary state machine by providing an early firing decision. An early firing decision refers to a signal unloading the accumulated strokes and delivering the best guess to the user before the state machine reaches its limit. Such a signal can be derived when the winning hypothesis has a very high confidence in the latest recognized symbols. The conclusion on the latest observation in the meantime helps boost the confidence in the other exclusive part of the sequence.

Control module 250 receives symbol and words from temporal segmenter 240 and recognized gestures from gesture recognizer 220. Control module 250 is operable to display the symbols and words on display device 106 of exemplary small form factor electronic device 260. Control module 250 is also operable to take appropriate action in response to receipt of a gesture, e.g., start a new word or insert a space.

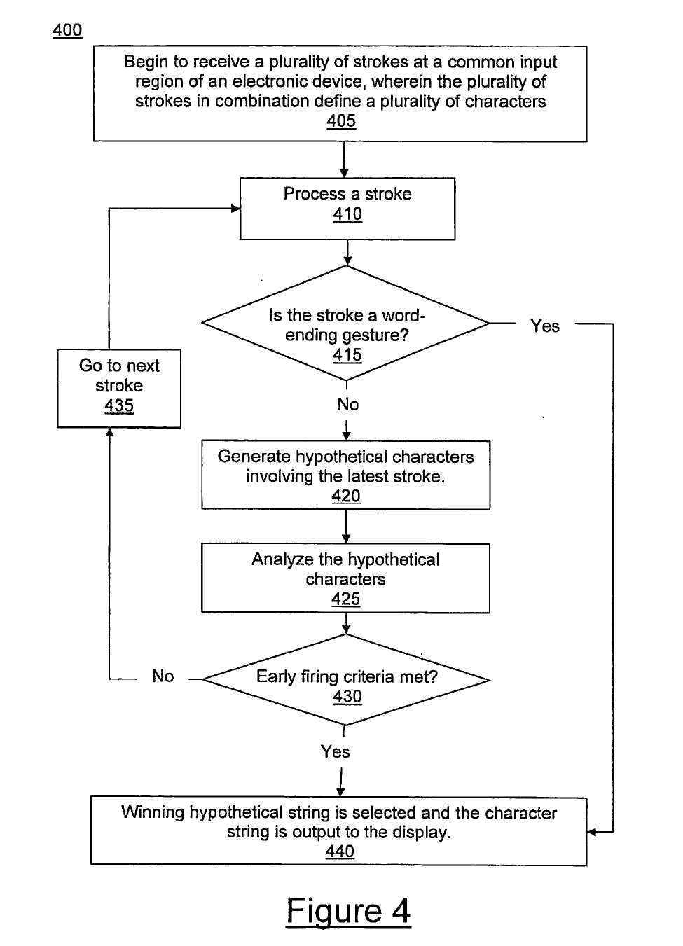

FIG. 4 is a flowchart diagram illustrating steps in a process 400 for recognizing handwritten symbols, in accordance with one embodiment of the present invention. In one embodiment, process 400 is carried out by processors and electrical components under the control of computer readable and computer executable instructions. The computer readable and computer executable instructions reside, for example, in data storage features such as computer usable volatile and non-volatile memory. However, the computer readable and computer executable instructions may reside in any type of computer readable medium. Although specific steps are disclosed in process 400, such steps are exemplary. That is, the embodiments of the present invention are well suited to performing various other steps or variations of the steps recited in FIG. 4. In one embodiment, process 400 is performed by handwriting recognition engine 105 of FIG. 2.

At step 405 of FIG. 4, a common input region of an electronic device begins receiving a plurality of strokes, wherein the plurality of strokes in combination defines a plurality of symbols. In one embodiment, at least one stroke of a first symbol of the plurality of symbols is spatially superimposed over at least one stroke of a second symbol of the plurality of symbols, wherein each stroke of the plurality of strokes is associated with only one symbol of the plurality of symbols. In one embodiment, the plurality of symbols comprises phonetic representations of an ideographic language. In one embodiment, a symbol of the plurality of symbols comprises no more than four strokes.

At step 410, a stroke is processed. At step 415, it is determined whether the stroke is a word-ending gesture. If the stroke is a word-ending gesture, process 400 proceeds to step 440. Alternatively, if the stroke is not a word-ending gesture, process 400 proceeds to step 420. At step 420, hypothetical symbols involving the stroke are generated. In one embodiment, the hypothetical symbols include sequential combinations of the stroke and previously processed strokes.

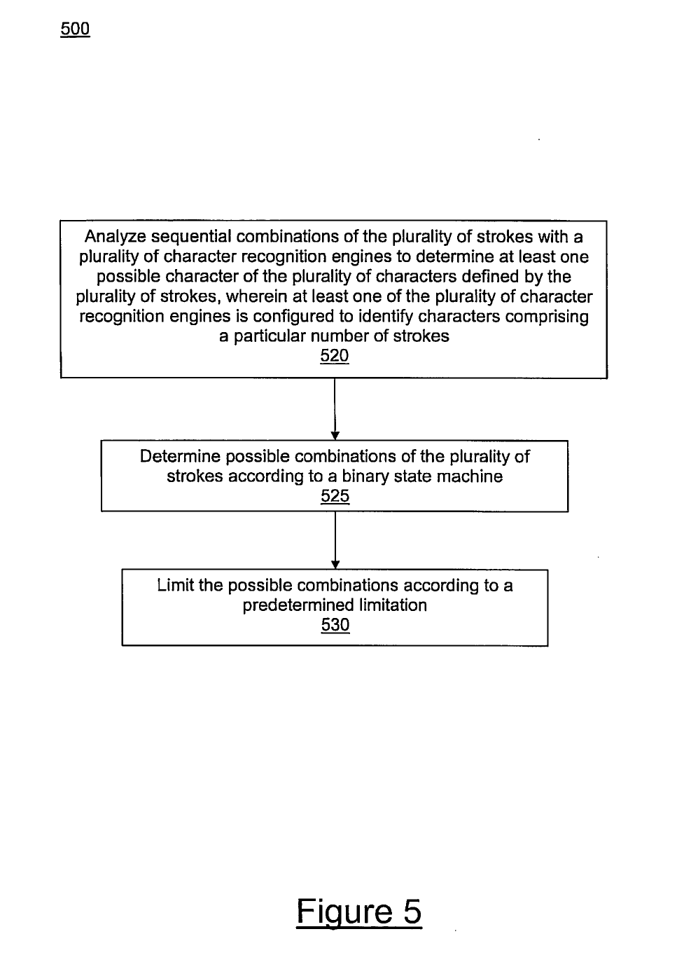

At step 425, the hypothetical symbols are analyzed. In one embodiment, the hypothetical symbols are analyzed according to process 500 of FIG. 5.

FIG. 5 is a flowchart diagram illustrating steps in a process 500 for analyzing a plurality of strokes, in accordance with one embodiment of the present invention. In one embodiment, process 500 is carried out by processors and electrical components under the control of computer readable and computer executable instructions. The computer readable and computer executable instructions reside, for example, in data storage features such as computer usable volatile and non-volatile memory. However, the computer readable and computer executable instructions may reside in any type of computer readable medium. Although specific steps are disclosed in process 500, such steps are exemplary. That is, the embodiments of the present invention are well suited to performing various other steps or variations of the steps recited in FIG. 5. In one embodiment, process 500 is performed by handwriting recognition engine 105 of FIG. 2.

At step 520, sequential combinations of the plurality of strokes are analyzed with a plurality of symbol recognition engines to determine at least one possible symbol of the plurality of symbols defined by the plurality of strokes. In one embodiment, the plurality of symbol recognition engines comprises statistical classifiers. In one embodiment, at least one of the plurality of symbol recognition engines is configured to identify symbols comprising a particular number of strokes.

Symbol combinations such as ligatures, dipthongs, etc. may be written with one or more strokes in common. In one embodiment, at least two symbols of the plurality of symbols connected by at least one common stroke are recognized by one or more of the symbol recognition engines, the gesture recognizer, or an additional recognizer optimized for this task.

In one embodiment, the analyzing does not require the use of an external mechanism to identify the possible symbol. In one embodiment, the external mechanism that is not required comprises at least one of an external segmenting signal and a stroke dictionary, such as a stroke dictionary comprising information describing relative positions of strokes between symbol bigrams.

In one embodiment, the plurality of symbol recognition engines comprises a one stroke symbol recognition engine, a two stroke symbol recognition engine, a three stroke symbol recognition engine. In one embodiment, the plurality of symbol recognition engines also comprises a four stroke symbol recognition engine.

At step 525, possible combinations of the plurality of strokes are determined according to a binary state machine. At step 530, the possible combinations are limited according to a predetermined limitation. In one embodiment, process 500 than proceeds to step 430 of FIG. 4.

With reference to FIG. 4, at step 430 it is determined whether the early firing criteria are met. In one embodiment, the early firing criteria are met when the last hypothetical symbol in the winning hypothesis has a very high confidence and is known not to be a subset of any other symbol. If the early firing criteria are not met, process 400 proceeds to step 435, where the next stroke is accessed for processing, and process 400 proceeds to step 410. Alternatively, if the early firing criteria are met, a partially finished string of symbols is selected from the possible combinations. In one embodiment, as shown at step 440, the winning hypothetical string is output to a display device, e.g., display device 106 of FIG. 1, and process 400 is reset for the next stroke sequence.

Various embodiments of the present invention, a method and apparatus for recognition of handwritten symbols, are thus described. While the present invention has been described in particular embodiments, it should be appreciated that the present invention should not be construed as limited by such embodiments, but rather construed according to the below claims.

What is claimed is:

1. A method for recognizing handwritten symbols comprising:
receiving a plurality of strokes at a common input region of an electronic device, wherein said plurality of strokes in combination define a plurality of symbols; and
analyzing sequential combinations of said plurality of strokes with a plurality of symbol recognition engines to determine at least one possible symbol of said plurality of symbols defined by said plurality of strokes, wherein at least one of said plurality of symbol recognition engines is configured to identify symbols comprising a particular number of strokes.

2. The method as recited in claim 1 wherein said analyzing does not require the use of an external mechanism to identify said possible symbol.

3. The method as recited in claim 2 wherein said external mechanism comprises at least one of an external segmenting signal and an external stroke dictionary.

4. The method as recited in claim 1 wherein said plurality of symbol recognition engines comprises a one stroke symbol recognition engine, a two stroke symbol recognition engine, and a three stroke symbol recognition engine.

5. The method as recited in claim 4 wherein said plurality of symbol recognition engines further comprises a four stroke symbol recognition engine.

6. The method as recited in claim 1 wherein a symbol of said plurality of symbols comprises no more than four strokes.

7. The method as recited in claim 1 wherein at least one stroke of a first symbol of said plurality of symbols is spatially superimposed over at least one stroke of a second symbol of said plurality of symbols, wherein each stroke of said plurality of strokes is associated with only one symbol of said plurality of symbols.

8. The method as recited in claim 1 wherein said analyzing sequential combinations of said plurality of strokes comprises:
determining possible combinations of said plurality of strokes according to a binary state machine; and
limiting said possible combinations according to a predetermined limitation.

9. The method as recited in claim 1 wherein said plurality of symbols comprises phonetic representations of an ideographic language.

10. The method as recited in claim 1 wherein said analyzing sequential combinations of said plurality of strokes comprises:
determining whether a stroke of said plurality of strokes represents a non-symbol gesture; and
ignoring said stroke at said plurality of symbol recognition engines if said stroke represents a non-symbol gesture.

11. The method as recited in claim 1 wherein said plurality of symbol recognition engines comprises statistical classifiers.

12. The method as recited in claim 1 wherein said analyzing sequential combinations of said plurality of strokes comprises recognizing at least two symbols of said plurality of symbols connected by at least one common stroke.

13. A method for recognizing and segmenting handwritten symbols without the use of an external segmentation mechanism, said method comprising:
receiving a plurality of strokes at a common input region of an electronic device, wherein said plurality of strokes in combination define a plurality of symbols and wherein at least one stroke of a first symbol is spatially superimposed over at least one stroke of a second symbol, wherein each stroke of said plurality of strokes is associated with only one symbol of said plurality of symbols; and
sequentially analyzing said plurality of strokes to determine at least one possible symbol defined by said plurality of strokes, wherein said sequentially analyzing does not require the use of at least one of an external segmenting signal and an external stroke dictionary to identify said possible symbol, wherein said sequentially analyzing is performed online.

14. The method as recited in claim 13, wherein said external segmenting signal comprises a timeout signal.

15. The method as recited in claim 13, wherein said external stroke dictionary comprises information describing relative positions of strokes between symbol bigrams.

16. The method as recited in claim 13 wherein said sequentially analyzing said plurality of strokes comprises utilizing a plurality of symbol recognition engines to determine at least one possible symbol of said plurality of symbols defined by said plurality of strokes, wherein at least one of said plurality of symbol recognition engines is configured to identify symbols comprising a particular number of strokes

17. The method as recited in claim 16 wherein said plurality of symbol recognition engines comprises a one stroke symbol recognition engine, a two stroke symbol recognition engine and a three stroke symbol recognition engine.

18. The method as recited in claim 17 wherein said plurality of symbol recognition engines further comprises a four stroke symbol recognition engine.

19. The method as recited in claim 13 wherein a symbol of said plurality of symbols comprises no more than four strokes.

20. The method as recited in claim 13 wherein said sequentially analyzing said plurality of strokes comprises:
determining possible combinations of said plurality of strokes according to a binary state machine; and
limiting said possible combinations according to a predetermined limitation.

21. The method as recited in claim 13 wherein said plurality of symbols comprises phonetic representations of an ideographic language.

22. The method as recited in claim 13 wherein said sequentially analyzing said plurality of strokes comprises:
determining whether a stroke of said plurality of strokes represents a non-symbol gesture; and
ignoring said stroke if said stroke represents a non-symbol gesture.

23. The method as recited in claim 16 wherein said plurality of symbol recognition engines comprises statistical classifiers.

24. An apparatus for recognition of handwritten symbols comprising:
a stroke receiver for receiving a plurality of strokes entered into a common input region, wherein said plurality of strokes in combination define a plurality of symbols and wherein at least one stroke of a first symbol is spatially superimposed over at least one stroke of a second symbol; and
a stroke analyzer for sequentially analyzing said plurality of strokes to determine at least one possible symbol defined by said plurality of strokes, said stroke analyzer comprising:
a plurality of symbol recognition engines for analyzing sequential combinations of said plurality of strokes, wherein said plurality of symbol recognition engines are for identifying symbols comprising a particular number of strokes.

25. The apparatus as recited in claim 24 wherein said plurality of symbol recognition engines comprises:
a one stroke symbol recognition engine for identifying symbols comprising one stroke;
a two stroke symbol recognition engine for identifying symbols comprising two strokes; and
a three stroke symbol recognition engine for identifying symbols comprising three strokes.

26. The apparatus as recited in claim 25 wherein said plurality of symbol recognition engines further comprises a four stroke symbol recognition engine for identifying symbols comprising four strokes.

27. The apparatus as recited in claim 24 wherein each of said plurality of symbol recognition engines determines a probability value that strokes analyzed by a respective symbol recognition engine of said plurality of symbol recognition engines is said possible symbol.

28. The apparatus as recited in claim 24 wherein said stroke receiver is a stroke input device of a handheld computing device.

29. The apparatus as recited in claim 24 wherein a symbol of said plurality of symbols comprises no more than four strokes.

30. The apparatus as recited in claim 24 wherein each stroke of said plurality of strokes is associated with only one symbol of said plurality of symbols.

31. The apparatus as recited in claim 24 wherein said stroke analyzer is configured for determining possible combinations of said plurality of strokes according to a binary state machine and limiting said possible combinations according to a predetermined limitation.

32. The apparatus as recited in claim 24 wherein said plurality of symbols comprises phonetic representations of an ideographic language.

33. The apparatus as recited in claim 24 wherein said stroke analyzer is configured for determining whether a stroke of said plurality of strokes represents a non-symbol gesture and for ignoring said stroke at said plurality of symbol recognition engines if said stroke represents a non-symbol gesture.

34. The apparatus as recited in claim 24 wherein said plurality of symbol recognition engines comprises statistical classifiers.

35. The apparatus as recited in claim 24 wherein at least one symbol recognition engine of said plurality of symbol recognition engines is configured to recognize at least two symbols of said plurality of symbols connected by at least one common stroke.
